(19) United States
(12) Patent Application Publication
(10) Pub. No.: US 2015/0379628 A1
(43) Pub. Date: Dec. 31, 2015

(54) PAYMENT PARSING MANAGEMENT SERVICES SYSTEMS AND METHODS

(71) Applicant: Emotive Labs, Inc., Seattle, WA (US)

(72) Inventor: Arry Shin YU, Seattle, WA (US)

(21) Appl. No.: 14/755,348

(22) Filed: Jun. 30, 2015

Related U.S. Application Data
(60) Provisional application No. 62/019,190, filed on Jun. 30, 2014.

(51) Int. Cl. G06Q 40/00

(52) U.S. Cl. CPC G06Q 40/00

(57) ABSTRACT

Provided herein are systems and methods for providing individuals and entities with coordinated segmented-purchasing-plan (“SPP”) management services. A payment parsing manager may enable SPP-creator to create a segmented-purchasing-plan to coordinate the purchase of deliverable by participants (“SPP-participants) on behalf of a receiver (the “SPP-recipient”), i.e. an individual or entity who is ultimately intended to receive the deliverable, if the purchase of the deliverable is funded. The purchase price of a segmented-purchasing-plan's deliverable is divided into parts, or “deliverable-segments.” The SPP-creator, SPP-participants, and, in some cases, the SPP-recipient, may selectively purchase deliverable-segments of the deliverable until the entire purchase price of the deliverable has been funded. For example, if the purchase price of a deliverable is $500, the SPP-creator may select to divide the $500 purchase price into five $100 deliverable-segments, ten $50 deliverable-segments, fifty $10 deliverable-segments, etc.

### FIELD

The present disclosure relates to computing, and more particularly, to systems and methods for facilitating distributed group funding of a purchasable product or service.

### BACKGROUND

Crowdfunding is the practice of raising funds for a project or venture by obtaining monetary contributions from a relatively large number of people, typically via the internet. The crowdfunding model is fueled by three types of actors: the creator who proposes the idea and/or project to be funded; individuals or groups who support the idea and participate in its funding; and a management service that brings the parties together to fund the project, for example coordinated through a website.

Some conventional crowdfunding management services allow groups (also known as the “crowd”) to collectively finance or fund an initiative (for charitable causes, arts, nonprofit causes, and the like) and usually occur on internet platforms with one or more people. For example, one conventional crowdfunding management service, project creators choose a deadline and a minimum funding goal. If the goal is not met by the deadline, no funds are collected. If the goal is met, the money pledged by donors is collected using a third party payment processor. The crowdfunding management service aggregates the money collected and then disperses the money to the project creators, minus a service fee.

However, such conventional crowdfunding management systems do not allow participants to distinguish which portion of the funds represents that participant's contribution at any given time and consequently, at the time of funding, the participant may be unable to ascertain what portion of the total funds the participant contributed. Additionally, at the end of the crowdfunding campaign, the beneficiary of the campaign is typically provided with a form of cash (or gift card, gift certificate, or the like). Thus, conventional crowdfunding management services may handle the monetary collection and aggregation to finance the project (or product or initiative or the like), but do not partition nor aggregate the actual project (or product, service, initiative, etc.) in relation to the participant (contributor, giver, gifter, funder, buyer, etc.).

Group-funding management services, e.g. related to various wedding registry services, operate similarly to the conventional crowdfunding management services described above and allow individuals and/or entities to cooperatively fund the purchase of products and/or services on behalf of others, but also do not allow the participants to distinguish what portion of the purchase they are contributing and are similarly limited to coordinating the collection of funds rather than obtaining the actual product and/or service.

An individual or entity may desire to divide a relatively expensive purchase, such as a gift to be given to another, into smaller segments and the participating individuals or entities may desire to select not only whether or not to contribute at all, but also select the relative proportion of the total cost of the purchase they contribute.

### BRIEF DESCRIPTION OF THE DRAWINGS

FIG. 1 illustrates an exemplary network topology of a server-based payment parsing management system in accordance with at least one embodiment.

FIG. 2 illustrates several components of an exemplary client device in accordance with at least one embodiment.

FIG. 3 illustrates several components of an exemplary payment parsing management server in accordance with at least one embodiment.

FIGS. 4a-b illustrate first and second aspects of an exemplary payment parsing user interface in accordance with at least one embodiment.

FIGS. 5a-b illustrate an exemplary series of communications between various devices in accordance with at least one embodiment.

FIG. 6 illustrates an exemplary payment parsing user interface routine in accordance with at least one embodiment.

FIG. 7 illustrates an exemplary initial payment parsing data collection sub-routine in accordance with at least one embodiment.

FIG. 8 illustrates an exemplary remote sub-routine in accordance with at least one embodiment.

FIG. 9 illustrates an exemplary payment parsing data retrieval sub-routine in accordance with at least one embodiment.

FIG. 10 illustrates an exemplary remote payment parsing data look-up sub-routine in accordance with at least one embodiment.

FIG. 11 illustrates an exemplary deliverable-segment purchase sub-routine in accordance with at least one embodiment.

FIG. 12 illustrates an exemplary remote deliverable-segment payment processing sub-routine in accordance with at least one embodiment.

FIG. 13 illustrates an exemplary remote SPP-data-update sub-routine in accordance with at least one embodiment.

FIG. 14 illustrates an alternative second aspect of an exemplary payment parsing user interface in accordance with at least one embodiment.

FIG. 15 illustrates an alternative second aspect of an exemplary payment parsing user interface in accordance with at least one embodiment.

### DESCRIPTION

The detailed description that follows is represented largely in terms of processes and symbolic representations of operations by conventional computer components, including a processor, memory storage devices for the processor, connected display devices and input devices. Furthermore, these processes and operations may utilize conventional computer components in a heterogeneous distributed computing environment, including remote file servers, computer servers, and/or memory storage devices. Each of these conventional distributed computing components is accessible by the processor via a communication network, which may include, but is not limited to, the Internet.

The phrases “in one embodiment,” “in various embodiments,” “in some embodiments,” and the like are used repeatedly. Such phrases do not necessarily refer to the same embodiment. The terms “comprising,” “having,” and “including” are synonymous, unless the context dictates otherwise.

Reference is now made in detail to the description of the embodiments as illustrated in the drawings. While embodiments are described in connection with the drawings and related descriptions, there is no intent to limit the scope to the embodiments disclosed herein. On the contrary, the intent is to cover all alternatives, modifications, and equivalents. In alternate embodiments, additional devices, or combinations of illustrated devices, may be added to, or combined, without limiting the scope to the embodiments disclosed herein.

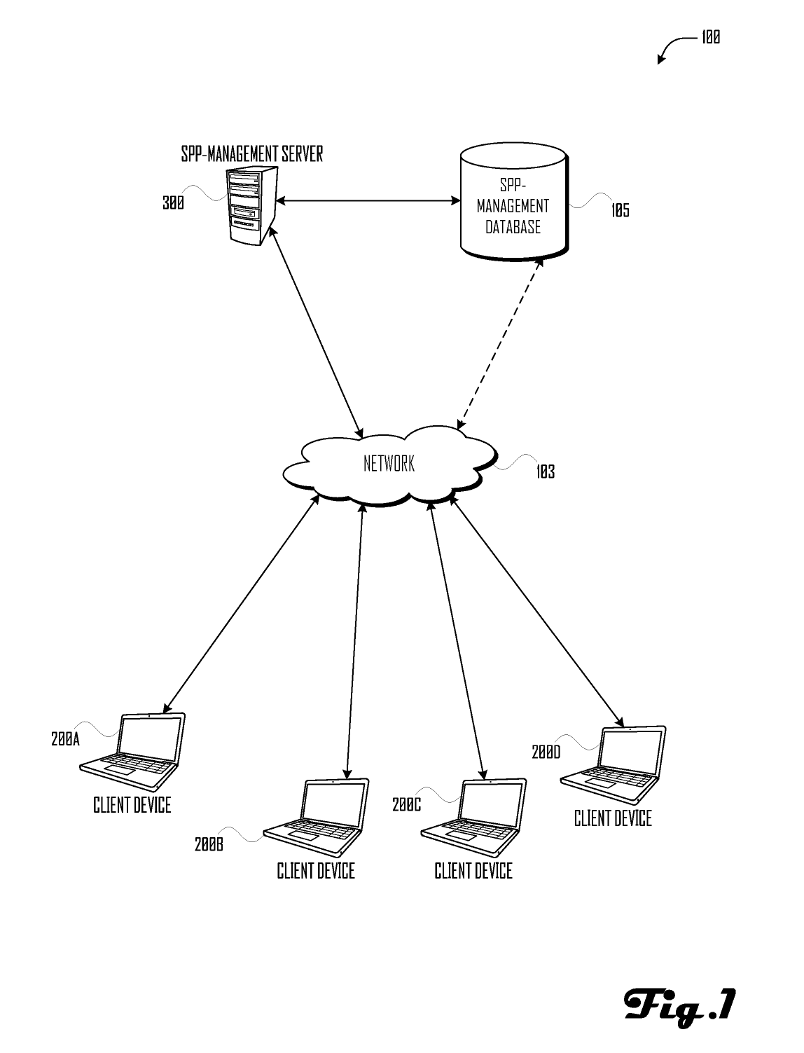

FIG. 1 illustrates an exemplary server-based payment parsing management system 100 in accordance with at least one embodiment. Client devices 200A-D and remote payment parsing management (“PPM”) server 300 are in data communication with a network 103. Remote PPM server 300 may be in data communication with a PPM database 105 either through a direct data connection or via network 103 (as indicated by dashed lines in FIG. 1). In various embodiments, network 103 may include the Internet, one or more local area networks (“LANs”), one or more wide area networks (“WANs”), cellular data networks, and/or other data networks. Network 103 may, at various points, be a wired and/or wireless network.

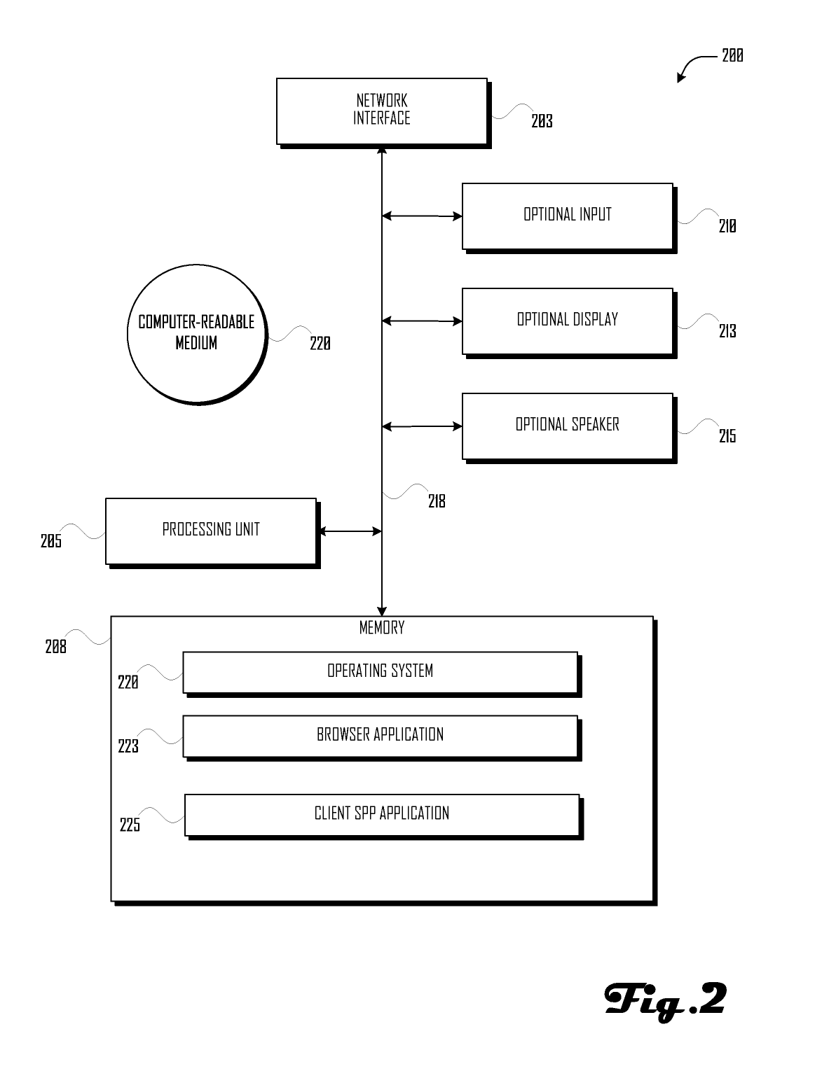

In various embodiments, client devices 200A-D may be networked computing devices having form factors such as mobile-phones; watches, glasses, or other wearable computing devices; dedicated media players; computing tablets; motor vehicle head units; audio-video on demand (AVOD) systems; dedicated media or gaming consoles; or general purpose computers. The functional components of an exemplary client device 200 are described below in reference to FIG. 2. In the illustrated embodiment, by way of example, four client devices are shown: client devices 200A-B, which are all general purpose computers. In various embodiments, there may be fewer or many more client devices 200.

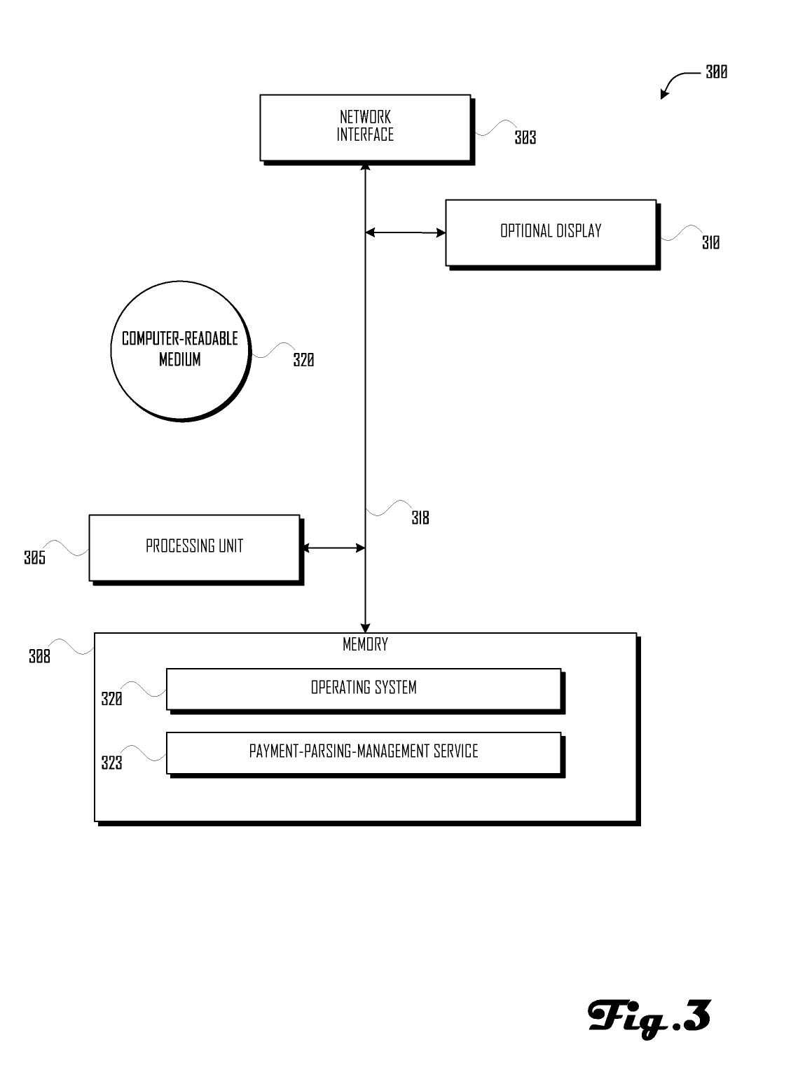

In various embodiments, remote PPM server 300 is a networked computing device generally capable of accepting requests over network 103, e.g. from client devices 200A-D, and providing responses accordingly. The functional components of an exemplary remote PPM server 300 are described below in reference to FIG. 3.

Referring to FIG. 2, several components of an exemplary client device 200, representative of client devices 200A-D, are illustrated. In some embodiments, a client device may include many more components than those shown in FIG. 2. However, it is not necessary that all of these generally conventional components be shown in order to disclose an illustrative embodiment. As shown in FIG. 2, exemplary client device 200 includes a network interface 203 for connecting to a network, such as network 103. Exemplary client device 200 also includes a processing unit 205, a memory 208, an optional user input 210 (e.g. an alphanumeric keyboard, keypad, a touchscreen, and/or a microphone), an optional display 213, an optional speaker 215, all interconnected along with the network interface 203 via a bus 320. The memory 208 generally comprises a RAM, a ROM, and a permanent mass storage device, such as a disk drive, flash memory, or the like.

Memory 208 of exemplary client device 200 stores an operating system 320 as well as program code for a number of software applications, such as browser application 323 and/or client PPM application 325. Memory 208 may also store data files (not shown) including data obtained and/or created by applications such as browser application 323 and/or client PPM application 325. These software components and data files may be loaded into memory 208 via network interface 203 (or via a computer readable storage medium 328, such as a memory card or the like).

Browser application 323 includes executable instructions for retrieving, presenting and traversing information resources located on a network, such as network 103. (An “information resource” may be a file representing a web page, image, video, program code, or other piece of content located on a network, identifiable via a Uniform Resource Identifier (URI), such as a Uniform Resource Locator (URL).) For example, browser application 323 may obtain additional program code corresponding to a web-based SPP-user interface from an information resource corresponding to a PPM service 323 (described below) on network 103 and execute the additional program code within the context of the browser application.

Client PPM application 325 includes executable instructions corresponding to an application based SPP-user interface.

Memory 208 may also store data files (not shown) including data obtained and/or created by applications such as browser application 323 and/or client PPM application 325. These software components and data files may be loaded into memory 208 via network interface 203 (or via a computer readable storage medium 328, such as a memory card or the like). Although an exemplary client device 200 has been described, a client device may be any of a great number of networked computing devices capable of communicating with network 103 and executing instructions for performing SPP-user interface routine 600.

In operation, the operating system 320 manages the hardware and other software resources of the client device 200 and provides common services for software applications, such as browser application 323 and/or client PPM application 325. For hardware functions such as network communications via network interface 203, receiving data via input 210, outputting data via optional display 213, and allocation of memory 208, operating system 320 acts as an intermediary between program code executing on the client device and hardware. (In the case of a web application, the browser application 323 similarly acts as an intermediary between the web application's program code and the operating system 320.)

For example, operating system 320 may cause a representation of available software applications, such as browser application 323 and/or client PPM application 325, to be presented to a user (not shown) of client device 200 via optional display 213. If the user indicates, e.g. via input optional 210, a desire to use browser application 323, operating system 320 may instantiate a browser application process (not shown), i.e. cause processing unit 205 to begin executing the executable instructions of the browser application and allocate a portion of memory 208 for its use.

Referring now to FIG. 3, several components of an exemplary remote interactive PPM server 300 in accordance with at least one exemplary embodiment are illustrated. In some embodiments, a remote interactive PPM server may include many more components than those shown in FIG. 3. However, it is not necessary that all of these generally conventional components be shown in order to disclose an illustrative embodiment. As shown in FIG. 3, remote interactive PPM server 300 includes a network interface 303 for connecting to a network, such as network 103. Remote interactive PPM server 300 also includes a processing unit 305, a memory 308, an optional user input 310, and an optional display 313, all interconnected along with the network interface 303 via a bus 318. The memory 308 generally comprises a random access memory (“RAM”), a read only memory (“ROM”), and a permanent mass storage device, such as a disk drive.

Memory 308 stores an operating system 320 and program code for a various software services, such as PPM service 323, accessible by applications operating on other devices on the network, such as client devices 200A-D. Program code for these and other such software services or components may be loaded from a non-transient computer readable storage medium 328 into memory 308 of the remote interactive PPM server 300 using a drive mechanism (not shown) associated with the non-transient computer readable storage medium, such as, but not limited to, a DVD/CD-ROM drive, memory card, or the like. Software may also be loaded into memory 308 via the network interface 303, rather than via a computer readable storage medium 328. Remote interactive PPM server 300 may also communicate via bus 318 with a database, such as PPM database 105, or other local or remote data store (not shown). In some embodiments, remote interactive PPM server 300 may comprise one or more replicated and/or distributed physical or logical devices.

Referring generally to FIGS. 1-3, in accordance with various embodiments, PPM service 323 may be operated in furtherance of a payment parsing manager that provides individuals and entities with coordinated payment parsing management services suitable for creating a segmented-purchasing-plan (“SPP”), such as a “gift-campaign” as shown in the present example. The payment parsing manager may enable an individual or entity (a “SPP-creator) to create a segmented-purchasing-plan to coordinate the purchase of an obtainable product or service (a “deliverable”) by participants in the segmented-purchasing-plan (“SPP-participants), i.e. individuals or entities who the SPP-creator hopes will fund the purchase of the deliverable and which may include the SPP-creator, on behalf of a receiver (the “SPP-recipient”), i.e. an individual or entity who is ultimately intended to receive the deliverable if the SPP is successful and the purchase of the deliverable is funded.

Also in accordance with various embodiments, the purchase price of a segmented-purchasing-plan's deliverable is divided into parts, or “deliverable-segments.” The SPP-creator, SPP-participants, and, in some cases, the SPP-recipient, may selectively purchase deliverable-segments of the purchase price until the entire purchase price of the deliverable has been funded. For example, if the purchase price of a deliverable is $500, the SPP-creator may select to divide the $500 purchase price into five $100 deliverable-segments, ten $50 deliverable-segments, fifty $10 deliverable-segments, etc. The SPP-creator may also specify differing sizes of deliverable-segments within a single segmented-purchasing-plan. Continuing the previous example, the SPP-creator may select to divide the purchase into two $100 deliverable-segments, four $50 deliverable-segments, and ten $10 deliverable-segments. In various embodiments, SPP-participants may selectively create a custom deliverable-segment for their own purchase. For example, if two $100 deliverable-segments remain, an SPP participant may elect to create and purchase a $40 deliverable-segment, in which case the PPM service 323 may automatically update the remaining deliverable-segments, e.g. to one $60 deliverable-segment and one $100 plan segment or two $80 deliverable-segments.

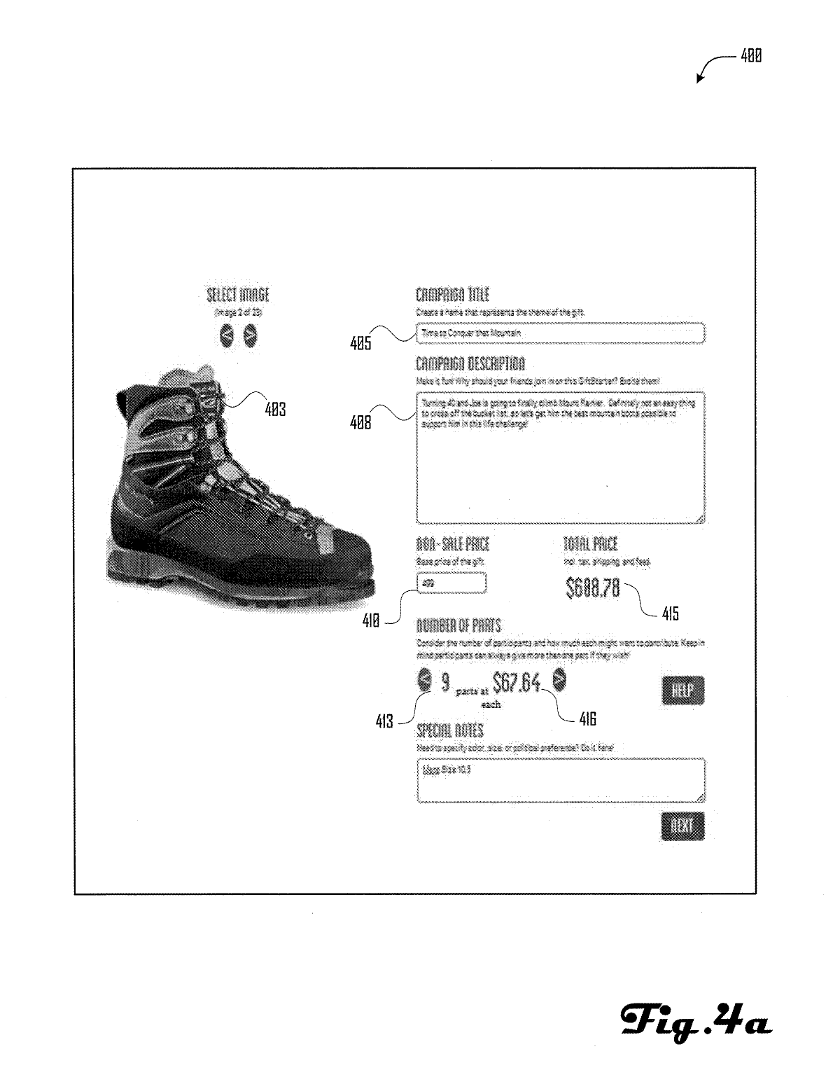

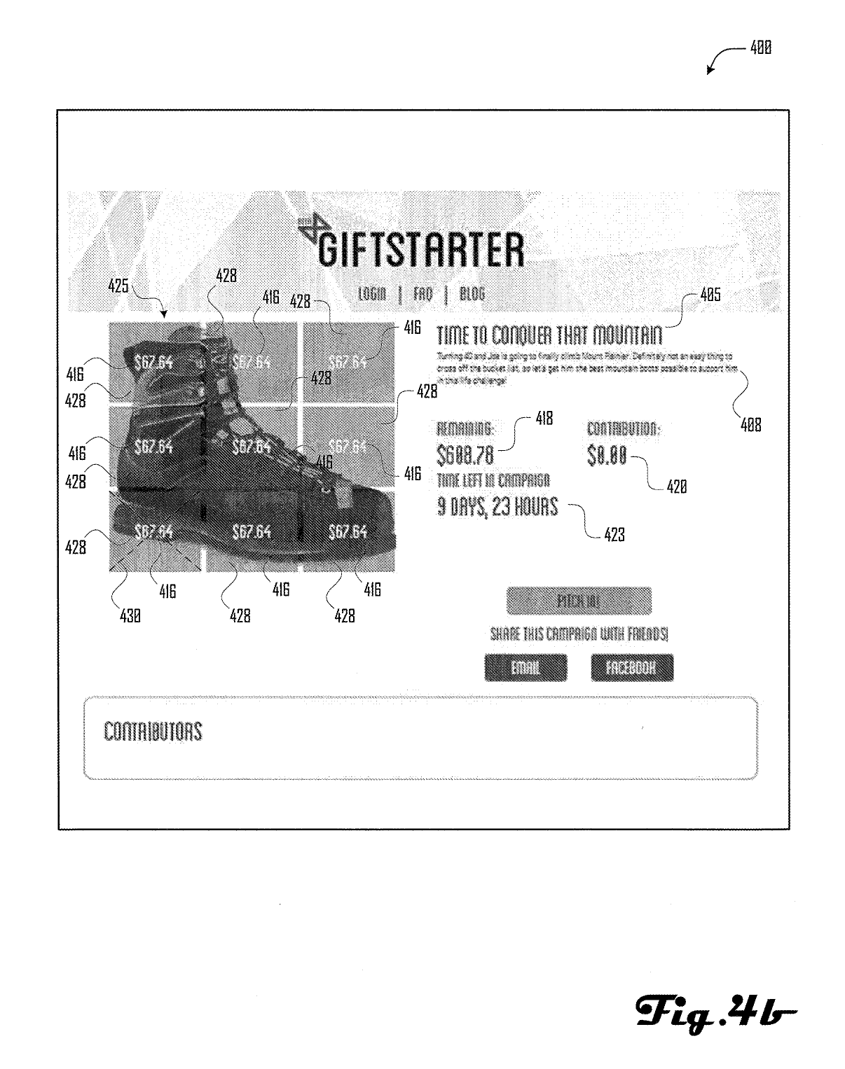

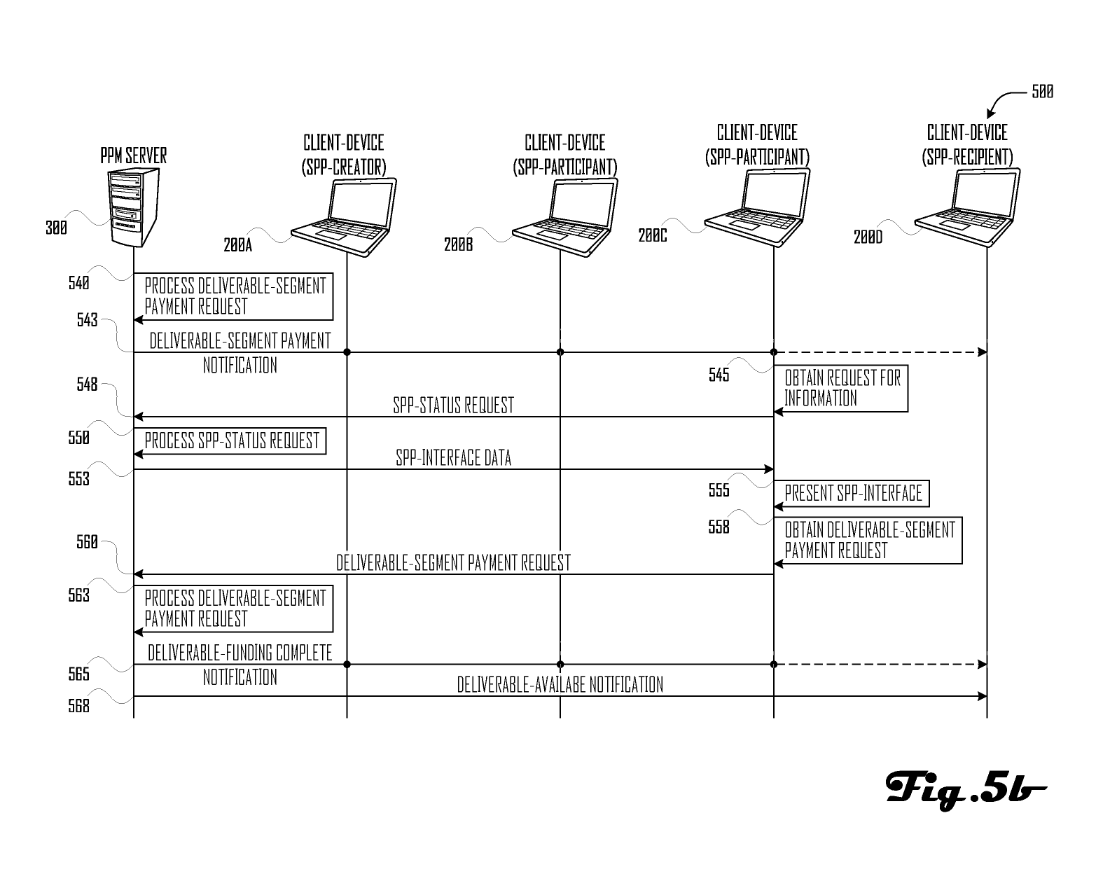

In order to permit a user of a client device, such as client devices 200A-D, to selectively create, view, edit, otherwise access a segmented-purchasing-plan, a SPP-user interface 400 (described below in reference to FIGS. 4a-b) is provided for facilitating interaction between the user and PPM service 323 over network 103. SPP-user interface 400 may be application-based or web-based. For example, browser application 223 may be instantiated on client device 200A and instructed to access the URI corresponding to the PPM service 323. PPM service 323 may then provide browser application 323 with program code corresponding to SPP-user interface routine 600 (described below in reference to FIG. 6), which then executes within the browser application, resulting in the rendering of SPP-user interface 400. Alternatively, program code corresponding to SPP-user interface routine 600 may be included within client PPM application 223 and executed upon instantiation of the client PPM application, resulting in the rendering of SPP-user interface 400.

Regardless of whether SPP-user interface 400 is application-based or web-based, SPP user-interface routine 600 may provide a log-in request to PPM service 323 via network 103, for example including user-account credentials such as a user name and password, obtained from the user or stored in memory 208. The user-account credentials may uniquely identify the particular user (or an entity upon whose behalf the user is acting, such as an employee acting on behalf of an employer) or may represent a generic, trial, and/or anonymous “guest” account. PPM service 323 may look up stored SPP-data associated with the provided user-account credentials in PPM database 105 and provide a response to SPP-user interface routine 600, which may include information related to features and services provided by the PPM service and related to segmented-purchasing-plans which the user-account is authorized to access.

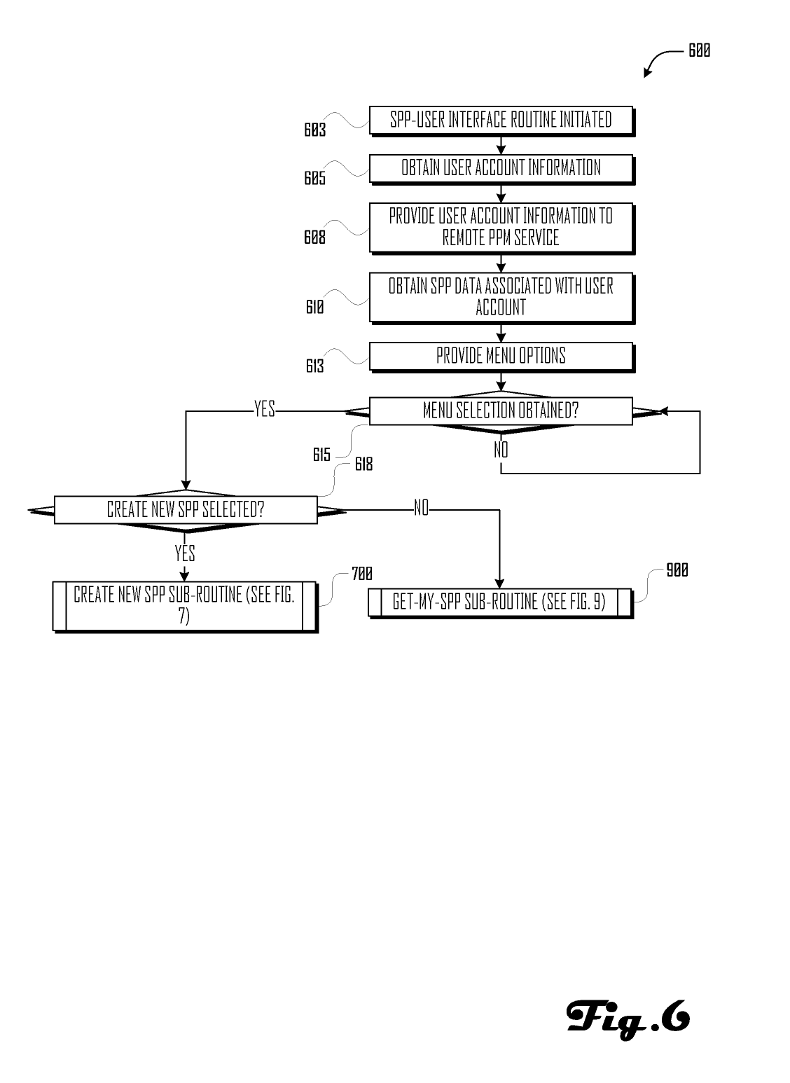

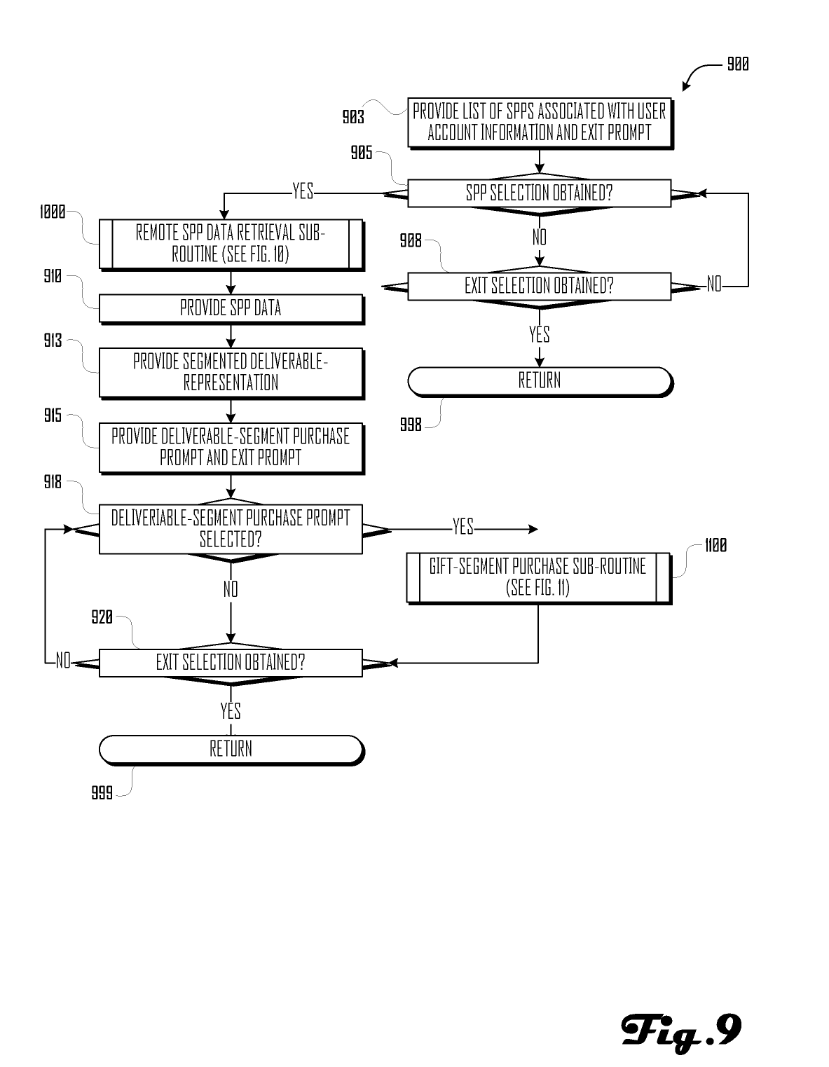

In accordance with various embodiments, SPP-user interface routine 600 may then present the user with a menu of options, such as “Create New Gift-Campaign” and/or “View My Gift-Campaigns” and wait for the user to indicate a selection of a specific option. Selection of the former option may cause SPP-user interface routine 600 to call an initial SPP-data collection sub-routine 700, described below in reference to FIG. 7, and to present a first aspect of SPP-user interface 400 (described below in reference to FIG. 4a). Selection of the latter option causes SPP-user interface routine 600 to call a SPP-data retrieval sub-routine 900, described below in reference to FIG. 9, and to present a second aspect of SPP-user interface 400 (described below in reference to FIG. 4b).

FIG. 4a illustrates a first aspect of an exemplary SPP-user interface 400, the first aspect being suitable for use in creating a new segmented-purchasing-plan in accordance with various embodiments. After identifying a deliverable, a SPP-creator may access SPP-user interface 400 to create a new segmented-purchasing-plan. SPP-user interface 400 obtains a deliverable representation 403 (described in more detail below), a segmented-purchasing-plan title 405, an optional segmented-purchasing-plan description 408, a deliverable purchase price 410, and the number of deliverable-segments 413 the purchase price 410 should be divided into. The SPP-user interface may also obtain identifiers (name, username, etc.) and/or contact information (e.g. email addresses, phone numbers, etc.) for one or more SPP-participants (not shown) and a SPP-recipient (not shown), a deadline for completing the segmented-purchasing-plan (not shown), and an initial purchase decision of one or more deliverable-segments by the SPP-creator (not shown). The SPP-user interface may also provide a total plan-price 415, corresponding to the deliverable purchase price 410 plus any applicable taxes and/or fees, and a per-segment price 416, corresponding to the total plan-price divided by the number of deliverable-segments 413.

Deliverable-representation 403 may be, for example, an image or a textual representation of the deliverable. For example, if the deliverable is a specific make and model of hiking boot, an effective deliverable representation may be a photographic image of the specific make and model hiking boot, a photographic image of a generic boot, a textual representation of phrase “HIKING BOOT,” etc. Deliverable representations are not limited to visual representations and do not need to be related to the deliverable. For example, in the above example a photographic image of the SPP-recipient or an image related to hiking could also be an appropriate deliverable-representation.

After the initial SPP-data is obtained via the SPP-user interface 400 and verified by the payment parsing manager (not shown), the payment parsing manager creates and stores records relating to the new segmented-purchasing-plan (“stored SPP-data”) and notifies the SPP-participants, e.g. via email, an SMS message, a “push” notification, and/or other form of notification. The SPP-participants may then selectively access information from the stored records relating to the segmented-purchasing-plan via SPP-user interface 400, and individually determine if they would like to participate in the segmented-purchasing-plan.

FIG. 4b illustrates a second aspect of the SPP-user interface 400, the second aspect being suitable for use in accessing the stored SPP-data relating to an existing segmented-purchasing-plan and selectively participating therein. Upon accessing SPP-user interface 400, a SPP-participant may be provided with a summary of the stored SPP-data related to the segmented-purchasing-plan. This may include: segmented-purchasing-plan title 405, optional segmented-purchasing-plan description 408, a remaining amount 418 (i.e. the total plan-price 415 minus contributions to-date, if any), a SPP-participant contribution 420 (i.e. the amount the particular SPP-participant has contribute to the segmented-purchasing-plan to-date), and an optional countdown 423, or other indicator for communicating how much time is left to fund the segmented-purchasing-plan.

A segmented deliverable-representation 425 is also provided, whereby the deliverable-representation selected by the SPP-creator is divided into one or more representation-segments 428, corresponding to the number of deliverable-segments selected by the SPP-creator. Each representation-segment 428 may be labeled with a per-segment price 416.

In the example illustrated in FIGS. 4a-b, the SPP-creator has elected to divide the total deliverable-price 415 of six hundred and eight dollars and seventy eight cents ($608.78) into nine (9) deliverable-segments 428 of sixty seven dollars and sixty four cents ($67.64).

If, at the time the current SPP-participant accesses the segmented-purchasing-plan via SPP-user interface 400, any deliverable-segments have already been purchased, e.g. by the SPP-creator or other SPP-participants, the SPP-user interface will distinguish a corresponding number of representation-segment(s) 428, e.g. by including a marker 430, shading the representation-segment(s) (not shown), or overlaying a picture (not shown), indicating to the current SPP-participant how many deliverable-segments have been purchased (one, in the example shown in FIG. 1b) and how many are still available (eight).

If the SPP-participant elects to purchase one or more deliverable-segments, he/she pays the payment parsing manager the cost of the deliverable-segments and the payment parsing manager updates the stored SPP-data and the segmented deliverable representation to reflect the purchase. The SPP-participant may optionally select which of the available representation segments are associated with the deliverable-segment purchase (or the payment parsing manager may make the selection). The SPP-participant may also optionally include additional information, such as a personalized message, picture, etc. to be associated with purchased deliverable-segments, which is also included as part of the stored SPP-data.

In accordance with various embodiments, after all the deliverable-segments have been purchased, meaning the deliverable is fully funded, the payment parsing manager will notify the SPP-recipient the deliverable is available. The payment parsing manager may also provide the SPP-recipient with compilation of any personalized messages, pictures, etc., which may have been obtained from the SPP-participants and/or the SPP-creator.

Also in accordance with various embodiments, the payment parsing manager may purchase the deliverable and provide the deliverable to the SPP-recipient. In such embodiments, the payment parsing manager may obtain the deliverable at a higher or lower cost than the original purchase price identified by the SPP-creator.

Note that, although the various examples described herein are generally described in terms of multiple actors, there is no requirement that the SPP-creator, the SPP participants, and/or the SPP recipient be separate individuals or entities. In a first example, a SPP-creator could utilize various embodiments as a type of “lay-away” service for making a purchase for his/her own use (i.e. purchasing a deliverable for his/her own use). In such a case, the SPP-creator would select the product he/she wishes to purchase and create a new segmented-purchasing-plan designating him/herself as the only SPP-participant and also as the SPP-recipient. The SPP-creator is then able to purchase deliverable-segments over time until the purchase is fully funded. In a second example, a SPP-creator may desire to receive a particular, relatively expensive deliverable instead of multiple less expensive deliverables from various people. In such a situation, the SPP-creator would create a new segmented-purchasing-plan for the desired deliverable, and designate him/herself as the SPP-recipient and others as the SPP-participants.

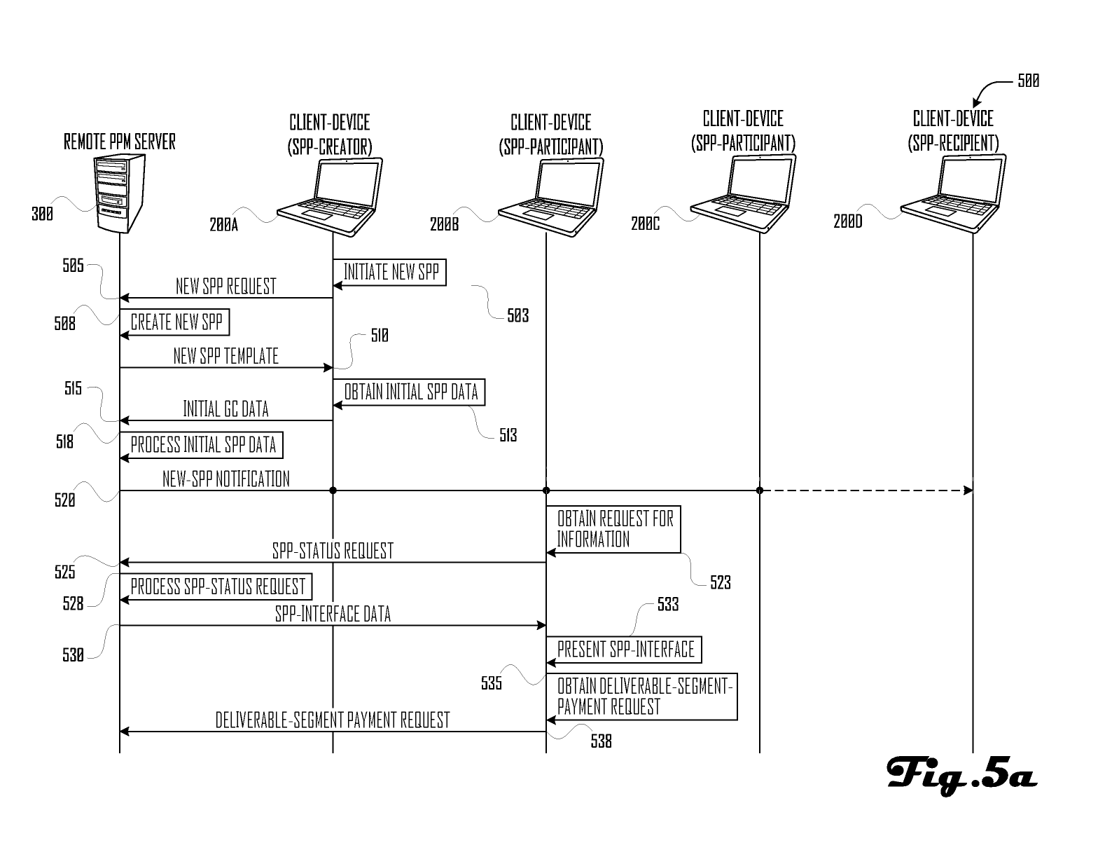

FIGS. 5a-b illustrate an exemplary series of initial communications between client devices 200A-D and remote PPM server 300 during the course of a segmented-purchasing-plan in accordance with various embodiments.

Referring to FIG. 5a, client device 200A initiates 503 a new segmented-purchasing-plan and provides remote PPM server 300 with a new SPP request 505, which may include user account information as described above.

Remote PPM server 300 creates 508 a new segmented-purchasing-plan, associates the new segmented-purchasing-plan with a unique SPP-identifier, and provides a new SPP template 510, including the SPP-identifier, to client device 200A. As is described above, by default the user account associated with the new SPP request is assigned both as the SPP-creator and as a SPP-participant for the new segmented-purchasing-plan.

Client device 200A processes the new SPP template and obtains 513 initial SPP data for the new segmented-purchasing-plan. As is described above, such initial SPP data may include identifying information for the deliverable, a deliverable representation selection, the source of the deliverable, the cost of the deliverable, the number of deliverable-segments, identifying information for one or more SPP-participants, and identifying information for the SPP-recipient.

Client device 200A provides the initial SPP data 515 to remote PPM server 300 and the remote PPM server processes 518 the initial SPP data, e.g. by associating the provided initial SPP data with the SPP-identifier and by creating a deliverable representation based on the provided deliverable representation selection.

Remote PPM server 300 then provides a new-SPP notification 520, including the SPP-identifier, to each SPP-participant and, optionally at the specification of the SPP-creator, to the SPP-recipient. (Note that although FIG. 5 depicts the this and other notifications as being provided to specific client-devices 200A-D, such notifications are user-specific, not device-specific. For example, the notifications could be provided via email to email addresses of the SPP-participants provided by the SPP-creator, which may be accessible from wide range of client devices.)

Client device 200B then obtains 523 a request for information pertaining to the new segmented-purchasing-plan, e.g. from a user of client device 200B, and provides a SPP-status request 525, including the SPP-identifier, to remote PPM server 300.

Remote PPM server 300 processes 528 the SPP-status request, e.g. by assembling SPP-interface data for the segmented-purchasing-plan and providing the SPP-interface data 530 to client device 200B.

Client device 200B presents 533 the SPP-interface using the SPP-interface data provided by remote PPM server 300 and obtains 535 a deliverable-segment-payment request. Client device 200B provides the deliverable-segment payment request 538 to remote PPM server 300. Deliverable-segment payment request 538 includes user-account information for the SPP-participant making the purchase, payment information, and specifies one or more deliverable-segments to be purchased.

Referring now to FIG. 5b, remote GMC server 300 processes 540 the deliverable-segment payment request, for example by processing payment information, associating the relevant deliverable-segments with the specified user-account, and determining the current status of the segmented-purchasing-plan (i.e. determining whether deliverable-segment payment request 538 completes the segmented-purchasing-plan).

Remote GMC server 300 then provides a deliverable-segment payment notification 543 to the SPP-creator (via client device 200A) and the SPP-participants (via client devices 200B-C) and optionally to the SPP-recipient (via client device 200D).

Client device 200C then obtains 545 a request for information pertaining to the segmented-purchasing-plan, e.g. from a user of client device 200C, and provides a SPP-status request 548, including the SPP-identifier, to remote PPM server 300.

Remote PPM server 300 processes 550 the SPP-status request, e.g. by assembling SPP-interface data for the segmented-purchasing-plan and providing the SPP-interface data 553 to client device 200B.

Client device 200B presents 555 the SPP-interface using the SPP-interface data provided by remote PPM server 300 and obtains 535 a deliverable-segment-payment request. Client device 200B provides the deliverable-segment payment request 538 to remote PPM server 300. Deliverable-segment payment request 560 includes user-account information for the SPP-participant making the purchase, payment information, and specifies one or more deliverable-segments to be purchased.

Remote GMC server 300 processes 563 the deliverable-segment payment request 560, for example by processing payment information, associating the relevant deliverable-segments with the specified user-account, determining the current status of the segmented-purchasing-plan, and, in the example illustrated in FIGS. 5a-b where deliverable-segment payment request completes the funding of the segmented-purchasing-plan, purchasing the deliverable.

Remote GMC server 300 then provides a SPP-funding complete notification 565 to the SPP-creator (via client device 200A) and the SPP-participants (via client devices 200B-C) and optionally to the SPP-recipient (via client device 200D).

Remote GMC server 200 provides a deliverable-available notification 568 to the SPP-recipient (via client device 200D).

FIG. 6 illustrates a SPP-user interface routine 600, which may be performed by various embodiments of browser application 223 or client PPM application 225 operating on a client device 200, such as client devices 200A-D.

Routine 600 is initialized on client device 200 at execution block 603.

Routine 600 obtains user-account information at execution block 605 and provides the user account information to remote PPM service 323 at execution block 608.

Routine 600 obtains SPP data associated with the user account at execution block 610 and provides menu options, including a “Create New Gift Campaign” option and a “View My Gift Campaigns” option, at execution block 613. Routine 600 then waits for a menu selection.

At decision block 615, if no selection is obtained, routine 600 continues waiting. If a selection is obtained at decision block 615, then routine 600 proceeds to decision block 618.

At decision block 618, if the “Create New Gift Campaign” option was selected, routine 600 calls initial SPP-data collection sub-routine 700. If the “Create New Gift Campaign” option was not selected, i.e. the “View My Gift Campaigns” option was selected, routine 600 calls SPP-data retrieval sub-routine 900.

FIG. 7 illustrates an exemplary initial SPP-data collection sub-routine 700, which may be performed by various embodiments of browser application 223 or client PPM application 225 operating on a client device 200, such as client devices 200A-D. At execution block 703, initial SPP-data collection sub-routine 700 obtains initial SPP-data, such as a desired deliverable, a deliverable representation, the identity of a SPP-recipient, the purchase price of the deliverable, the number of deliverable-segments the purchase price should be divided into, the identity of one or more SPP-participants, a deadline for completing the segmented-purchasing-plan, and an initial purchase request for one or more deliverable-segments.

Initial SPP-data collection sub-routine 700 then calls remote SPP-creation sub-routine 800. At decision block 705, if the segmented-purchasing-plan's creation is confirmed by remote SPP-creation sub-routine 800, then initial SPP-data collection sub-routine 700 returns a SPP-creation confirmation message at return block 798. If the segmented-purchasing-plan's creation is not confirmed by remote SPP-creation sub-routine 800 at decision block 705, then initial SPP-data collection sub-routine 700 returns a SPP-creation error message at return block 799.

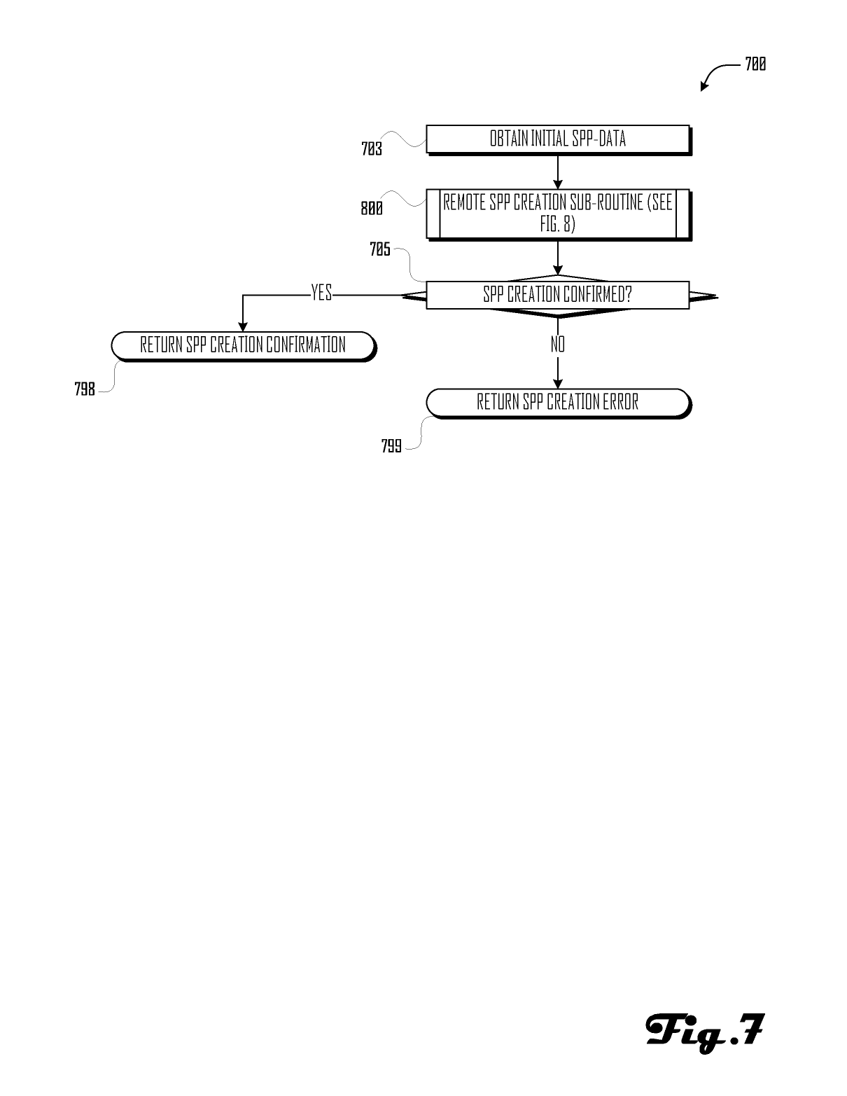

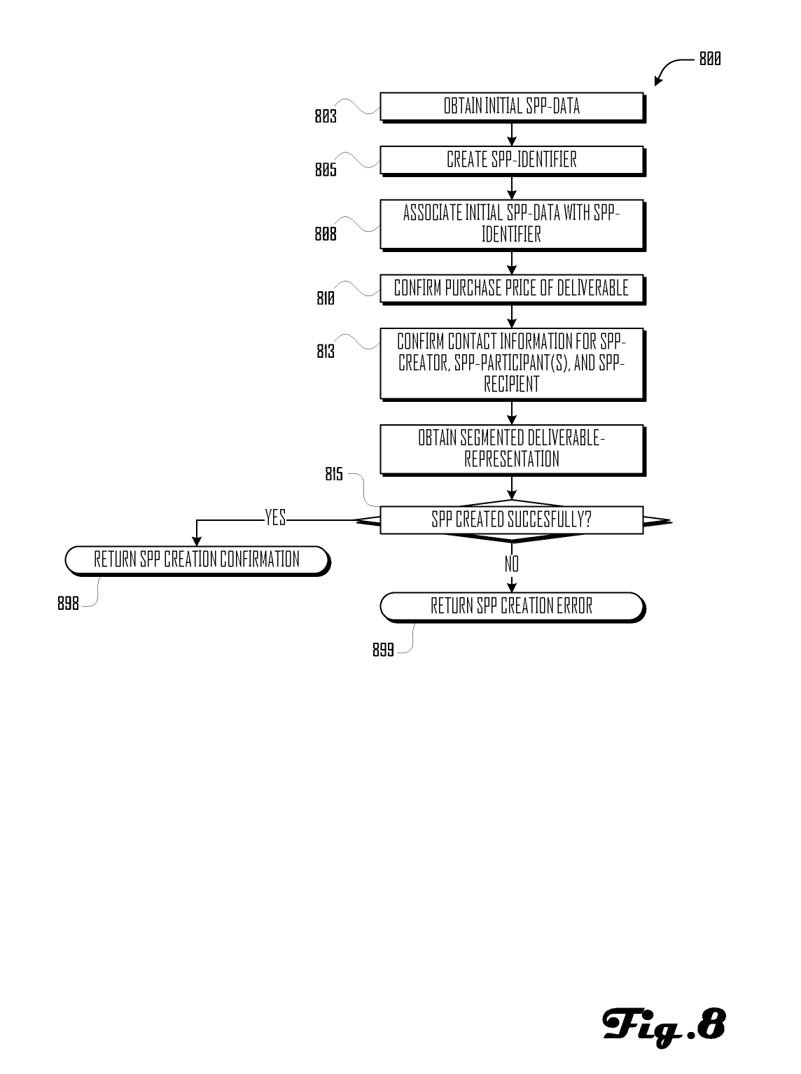

FIG. 8 illustrates remote SPP-creation sub-routine 800, which may be performed by various embodiments of remote PPM service 323 operating on remote PPM server 300.

Remote SPP-creation sub-routine 800 obtains a new SPP request including the initial SPP-data from initial SPP-data collection sub-routine 700 at execution block 803.

Remote SPP-creation sub-routine 800 creates a SPP-identifier for the new segmented-purchasing-plan at execution block 805 and stores the initial SPP-data, indexed by the SPP-identifier, e.g. in PPM database 105.

Remote SPP-creation sub-routine 800 confirms the provided purchase price of the deliverable at execution block 810 and confirms the contact information for the SPP-creator, the SPP-participant(s), and the SPP-recipient at execution block 813.

At decision block 815, if the segmented-purchasing-plan has been created successfully, then remote SPP-creation sub-routine 800 returns a SPP-creation confirmation message at return block 898. If, at decision block 815, the segmented-purchasing-plan has not been created successfully, then remote SPP-creation sub-routine 800 returns a SPP-creation error at return block 899.

FIG. 9 illustrates SPP-data retrieval sub-routine 900, which may be performed by various embodiments of browser application 223 or client PPM application 225 operating on a client device 200, such as client devices 200A-D.

At execution block 903, SPP-data retrieval sub-routine 900 provides a list of SPP prompts for the segmented-purchasing-plan(s) associated with the user account information (e.g. obtained at execution block 608, described above) and an exit prompt.

At decision block 905, if no SPP selection is obtained, SPP-data retrieval sub-routine 900 proceeds to decision block 908. At decision block 908, if an exit selection has been obtained, SPP-data retrieval sub-routine 900 returns to SPP-user interface routine 600 at return block 998. If, at decision block 908, the exit block has not been selected, SPP-data retrieval sub-routine 900 loops back to decision block 905.

Returning to decision block 905, if a segmented-purchasing-plan selection is obtained, SPP-data retrieval sub-routine 900 calls remote SPP-data look-up sub-routine 1000, which obtains SPP-data for the selected segmented-purchasing-plan, such as such as the desired deliverable, the identity of the SPP-recipient, the identity of the SPP-creator, the purchase price of the deliverable, the number of deliverable-segments the purchase price has been divided into, the number of deliverable-segments that have been purchased, the identity of any additional SPP-participants, the deadline for completing the segmented-purchasing-plan, and the segmented deliverable-representation.

SPP-data retrieval sub-routine 900 provides the SPP-data, including the segmented deliverable-representation, at execution block 910 and provides a deliverable-segment purchase prompt and an exit prompt at execution block 915.

At decision block 918, if a deliverable-segment purchase prompt is not selected, SPP-data retrieval sub-routine 900 proceeds to decision block 920. At decision block 920, if an exit selection has been obtained, SPP-data retrieval sub-routine 900 returns to SPP-user interface routine 600 at return block 999. If, at decision block 920, the exit block has not been selected, SPP-data retrieval sub-routine 900 loops back to decision block 918.

Returning to decision block 918, if the deliverable-segment purchase prompt is selected, then SPP-data retrieval sub-routine 900 calls deliverable-segment purchase sub-routine 1100, and then sub-routine proceeds to decision block 920. At decision block 920, if an exit selection has been obtained, SPP-data retrieval sub-routine 900 returns to SPP-user interface routine 600 at return block 999. If, at decision block 920, the exit prompt has not been selected, SPP-data retrieval sub-routine 900 loops back to decision block 918.

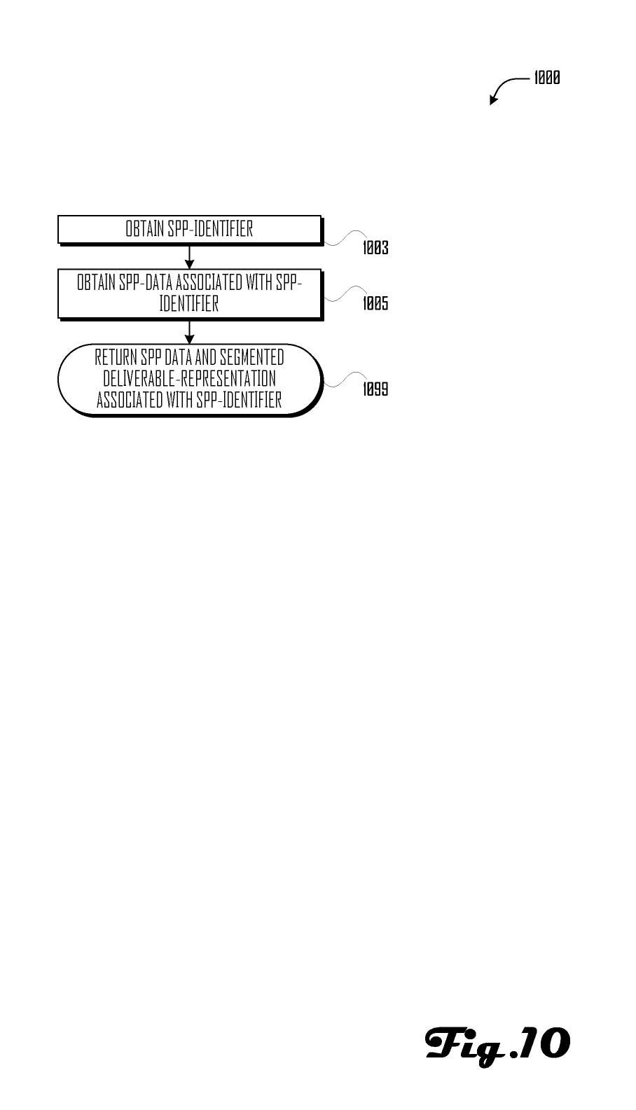

FIG. 10 illustrates an exemplary remote SPP-data look-up sub-routine 1000, which may be performed by various embodiments of remote PPM service 323 operating on remote PPM server 300.

At execution block 1003, remote SPP-data look-up sub-routine 1000 obtains a SPP-identifier, e.g. from SPP-data retrieval sub-routine 900.

Remote SPP-data look-up sub-routine 1000 obtains SPP-data, e.g. that is stored in PPM database 105, including a segmented deliverable-representation, associated with the SPP-identifier at execution block 1005.

Remote SPP-data look-up sub-routine 1000 returns the SPP-data at return block 1099.

FIG. 11 illustrates an exemplary deliverable-segment purchase sub-routine 1100, which may be performed by various embodiments of browser application 223 or client PPM application 225 operating on a client device 200, such as client devices 200A-D.

Deliverable-segment purchase sub-routine 1100 provides a representation-segment selection prompt and an exit prompt at execution block 1103.

At decision block 1105, if a representation-segment selection is not obtained, deliverable-segment purchase sub-routine 1100 proceeds to decision block 1108. At decision block 1108, if an exit selection has been obtained, deliverable-segment purchase sub-routine 1100 returns to SPP-data retrieval sub-routine 900 at return block 1198. If, at decision block 1108, the exit prompt has not been selected, deliverable-segment purchase sub-routine 1100 loops back to decision block 1105.

Returning to decision block 1105, if a representation-segment selection is obtained, deliverable-segment purchase sub-routine 1100 records the selected representation-segment identifiers and updates the segmented deliverable-representation at execution block 1110, e.g. by marking the selected representation segments as selected pending payment confirmation.

Deliverable-segment purchase sub-routine 1100 calculates the purchase price of the selected representation-segments at execution block 1113 and provides a payment prompt at execution block 1115.

At decision block 118, sub-routine waits for payment information to be provided. If payment information is obtained, deliverable-segment purchase sub-routine 1100 calls remote deliverable-segment payment processing sub-routine 1200.

At decision block 1120, if remote deliverable-segment payment processing sub-routine 1200 returns a payment processing error, deliverable-segment purchase sub-routine 1100 returns a payment processing error at return block 1198. If, at decision block 1120, remote deliverable-segment payment processing sub-routine 1200 returns a payment successful confirmation, deliverable-segment purchase sub-routine 1100 updates the locally stored SPP-data with the payment information at execution block 1123.

Deliverable-segment purchase sub-routine 1100 provides a personal message prompt at execution block 1125, e.g. so the user can optionally add a personalized message (such as text, pictures, etc.) relating to the purchased deliverable-segments.

At decision block 1128, if a personal message is obtained at execution block 1125, then at execution block 1130 sub-routine 100 updates the locally stored SPP-data with the personal message.

After updating the locally stored SPP-data at execution block 1130, or if no personal message is obtained at decision block 1128, deliverable-segment purchase sub-routine 1100 calls remote SPP-data-update sub-routine 1300 and then returns to SPP-data retrieval sub-routine 900 at return block 1199.

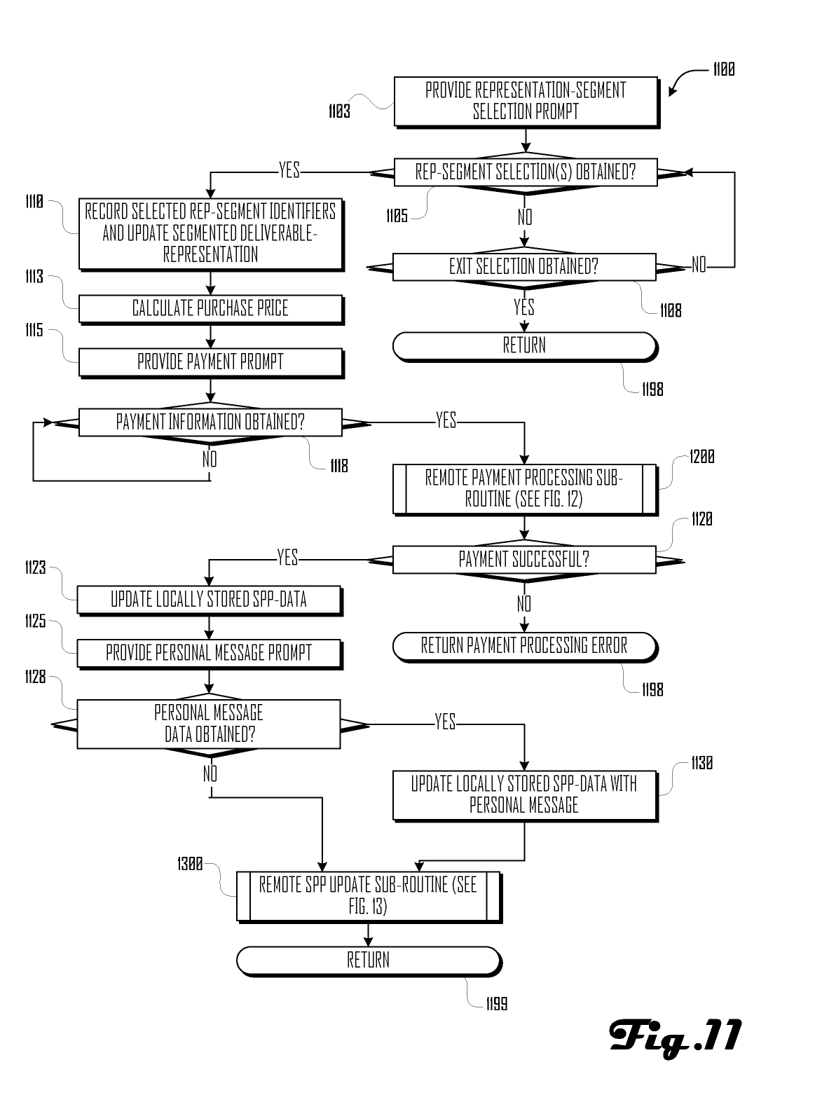

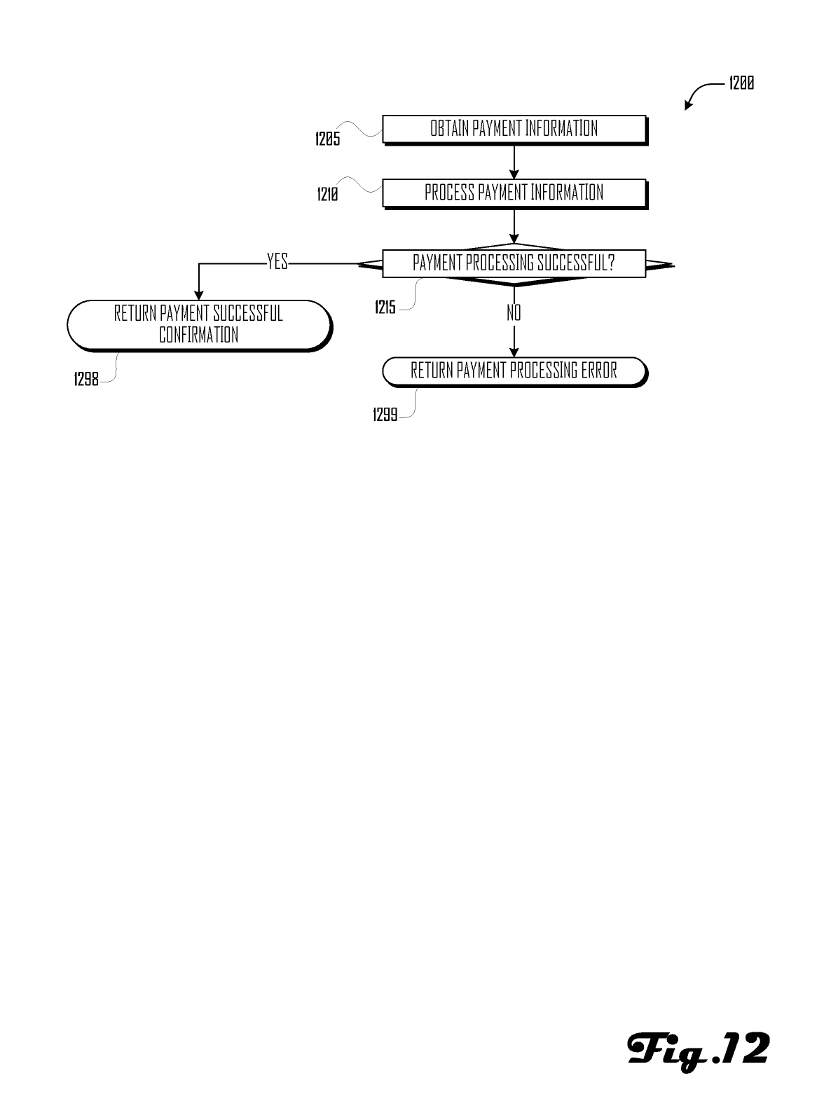

FIG. 12 illustrates an exemplary remote deliverable-segment payment processing sub-routine 1200, which may be performed by various embodiments of remote PPM service 323 operating on remote PPM server 300.

Remote deliverable-segment payment processing sub-routine 1200 obtains a deliverable-segment payment request, including payment information (e.g. credit card information, etc.) relevant SPP-identifier, SPP-participant identity, and selected representation-segment identifiers, at execution block 1205.

Remote deliverable-segment payment processing sub-routine 1200 processes the payment information at execution block 1210, e.g. through a third party credit card processor.

At decision block 1215, if the payment processing is successful, remote deliverable-segment payment processing sub-routine 1200 returns a payment successful confirmation at return block 1298. At decision block 1215, if the payment processing is not successful, remote deliverable-segment payment processing sub-routine 1200 returns a payment processing error message at return block 1299.

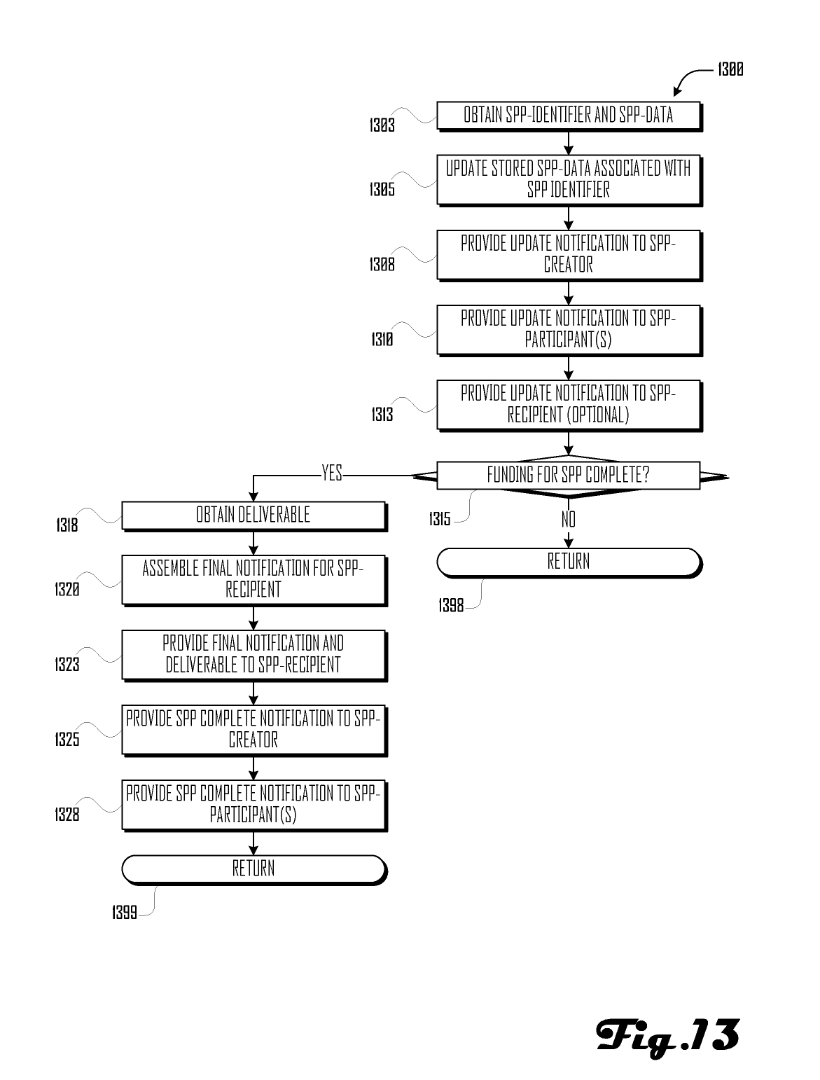

FIG. 13 illustrates a remote SPP-data-update sub-routine 1300, which may be performed by various embodiments of remote PPM service 323 operating on remote PPM server 300.

Remote SPP-data-update sub-routine 1300 obtains a SPP-identifier and associated SPP-data at execution block 1303.

Remote SPP-data-update sub-routine 1300 updates the stored SPP-data associated with the SPP-identifier to reflect the newly obtained SPP-data at execution block 1305.

Remote SPP-data-update sub-routine 1300 provides an update notification to the SPP-creator at execution block 1308, an update notification to the SPP-participant(s) at execution block 1310, and an optional update notification to the SPP-recipient at execution block 1313.

At decision block 1315, if the funding for the segmented-purchasing-plan is not complete, remote SPP-data-update sub-routine 1300 returns to deliverable-segment purchase sub-routine 1100 at return block 1398. If, at decision block 1315, the funding for the segmented-purchasing-plan is complete, SPP-data-update sub-routine 1300 obtains the deliverable at execution block 1318.

Remote SPP-data-update sub-routine 1300 assembles a final notification for the SPP-recipient, including any personal messages provided by the SPP-creator or any SPP-participants (e.g. at execution block 1130), at execution block 1320.

Remote SPP-data-update sub-routine 1300 provides the deliverable and the final notification to the SPP-recipient at execution block 1323.

Remote SPP-data-update sub-routine 1300 provides a SPP-complete notification to the SPP-creator at 1325 and provides a SPP-complete notification to the SPP-participant(s) at execution block 1328.

Remote SPP-data-update sub-routine 1300 then returns to deliverable-segment purchase sub-routine 1100 at return block 1399.

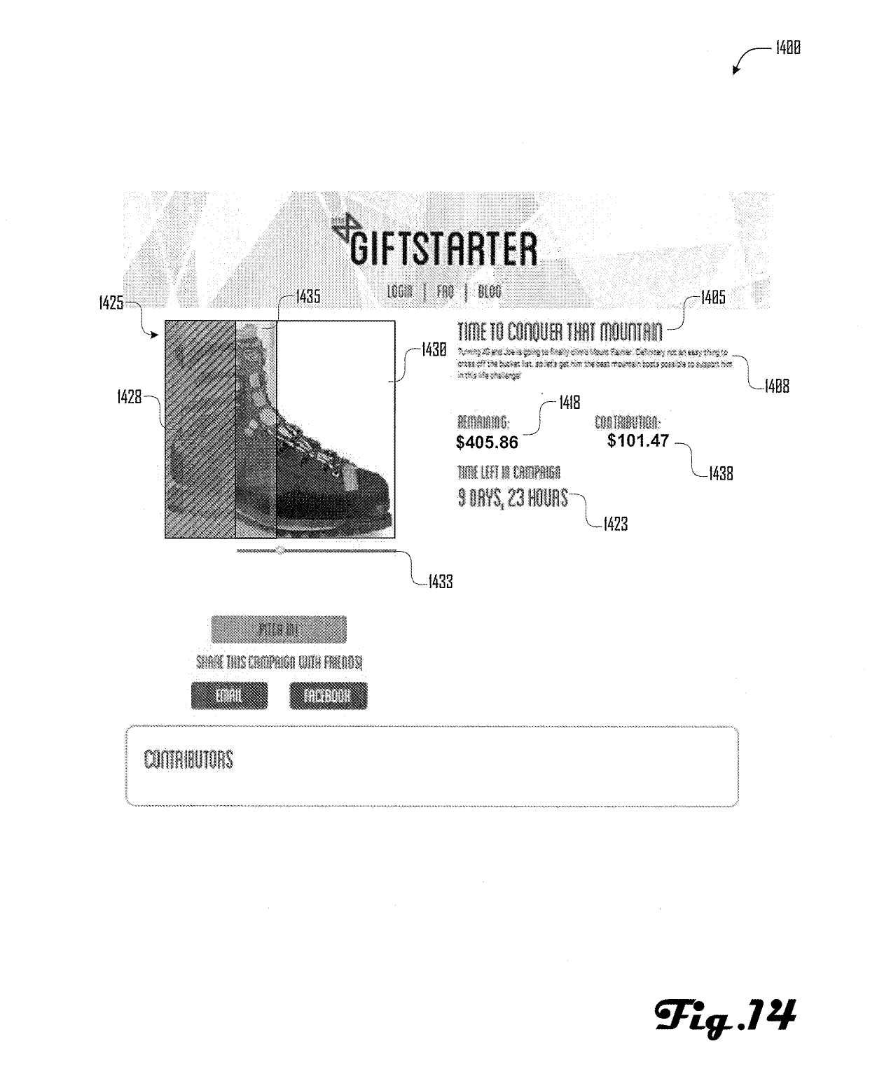

FIG. 14 illustrates an alternative implementation of the second aspect of the SPP-user interface 1400. Similar to the implementation described above in reference to FIG. 4b, SPP-user interface 1400 is suitable for use in accessing stored SPP-data relating to an existing segmented-purchasing-plan and selectively participating therein. Upon accessing SPP-user interface 1400, a SPP-participant may be provided with a summary of the stored SPP-data related to the segmented-purchasing-plan. This may include: segmented-purchasing-plan title 1405, optional segmented-purchasing-plan description 1408, a remaining amount 1418 (i.e. the total plan-price minus contributions to-date, if any), and an optional countdown 1423, or other indicator for communicating how much time is left to fund the segmented-purchasing-plan. A segmented deliverable-representation 1425 is also provided, whereby the deliverable-representation selected by the SPP-creator is divided into a purchased portion 1428 and a remaining portion 1430. A slider 1433 is provided for permitting an SPP-participant to vary the size of a selected portion 1435 of remaining portion 1430 the SPP-participant may wish to purchase. The price 1438 of selected portion 1435 may be dynamically calculated as the position of slider 1433 is adjusted.

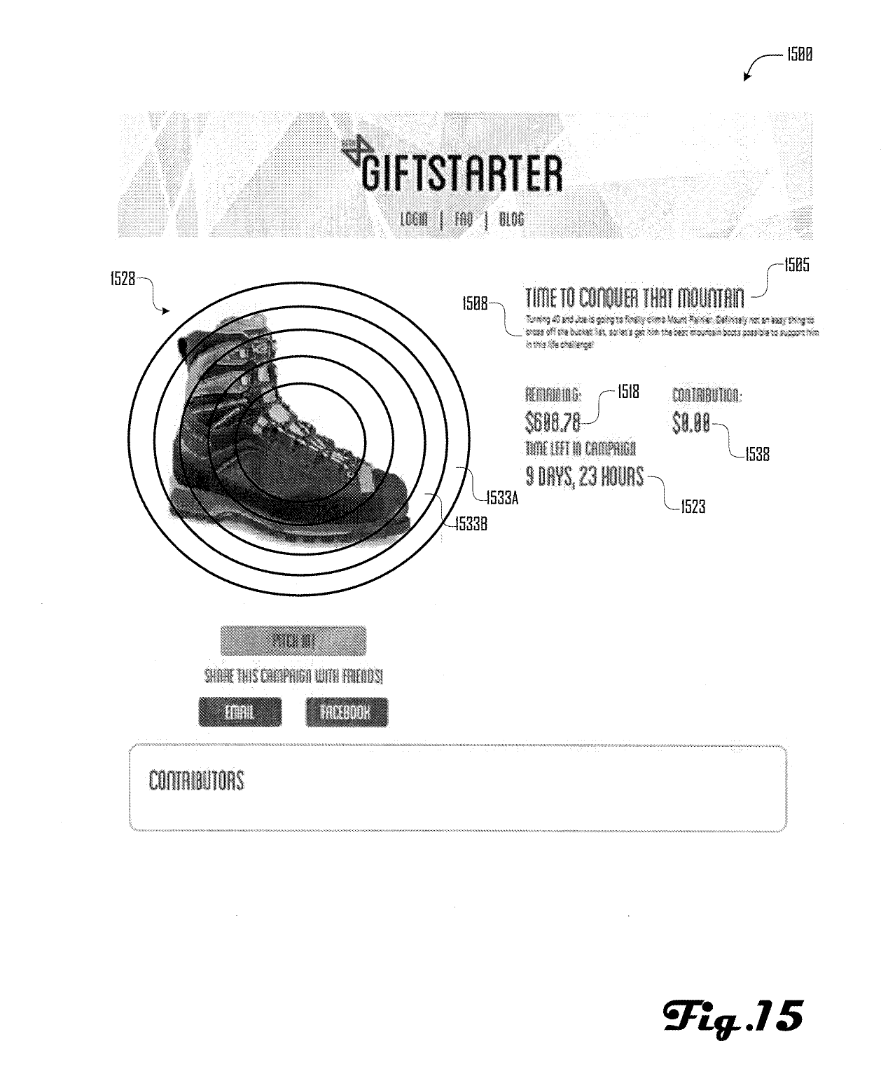

FIG. 15 illustrates an alternative implementation of the second aspect of the SPP-user interface 1500. Similar to the implementations described above in reference to FIGS. 4b and 16, SPP-user interface 1500 is suitable for use in accessing stored SPP-data relating to an existing segmented-purchasing-plan and selectively participating therein. Upon accessing SPP-user interface 1500, a SPP-participant may be provided with a summary of the stored SPP-data related to the segmented-purchasing-plan. This may include: segmented-purchasing-plan title 1505, optional segmented-purchasing-plan description 1508, a remaining amount 1518 (i.e. the total plan-price minus contributions to-date, if any), and an optional countdown 1523, or other indicator for communicating how much time is left to fund the segmented-purchasing-plan. A segmented deliverable-representation 1525 is also provided, whereby the deliverable-representation selected by the SPP-creator is divided into a “bulls-eye” of multiple concentric ring segments, e.g. outer concentric ring segments 1533A-B. The price of each concentric ring segment may vary; for example, the price of outer concentric ring segment 1533A may be the least expensive, the price of outer concentric ring segment 1533B may be incrementally more expensive than outer concentric ring segment 1533A, and so on towards the center of segmented deliverable-representation 1525.

Although specific embodiments have been illustrated and described herein, a variety of alternate and/or equivalent implementations may be substituted for the specific embodiments shown and described without departing from the scope of the present disclosure. This application is intended to cover any adaptations or variations of the embodiments discussed herein. For example, in some embodiments, a deliverable representation may represent a set of deliverables. For example, an SPP-creator may select as a deliverable representation a page from a retailer catalog displaying multiple items for purchase, such as an image of a staged room displaying multiple items of furniture and/or décor or an image of a model wearing multiple items of clothing and/or accessories. The SPP-creator may then select various desired items from the deliverable representation as deliverable-segments for the segmented purchasing plan. SPP-participants may then select and purchase one or more deliverable-segments (that correspond to a particular desired item).

By way of further example, various embodiments may permit nested/primary segmented-purchasing-plans, wherein a nested segmented-purchasing-plan's deliverable is a deliverable-segment in a primary segmented-purchasing-plan. One application of primary/nested segmented-purchasing-plans may be funding a wedding or other relatively complex event. For example, a SPP-creator may create a primary segmented-purchasing-plan representing the overall cost of a planned wedding ceremony wherein the primary segmented-purchasing-plan's representation-segments each represent a separate sub-segmented-purchasing-plan corresponding to various aspects of the wedding ceremony, such as the cost of the venue, the cost of catering, the cost of an officiant, the cost of entertainment, etc. The SPP-participants would view the segmented deliverable representation for the primary segmented-purchasing-plan and select representation-segment corresponding to a particular aspect, such as the cost of catering the wedding reception. The SPP-user interface may then present the user with a sub-segmented-purchasing-plan for catering the wedding reception, with its own segmented deliverable representation, etc.

1. A computer processor implemented method comprising the steps of:
obtaining initial segmented-purchasing-plan data relating to a segmented-purchasing-plan, the initial segmented-purchasing-plan data including a deliverable-representation, a deliverable-cost, and an initial number (N) of available deliverable-segments;
associating said initial segmented-purchasing-plan data with a segmented-purchasing-plan identifier;
obtaining a request for information relating to said segmented-purchasing-plan identifier;
obtaining a current number of available deliverable-segments;
obtaining a deliverable-segment cost associated with each available deliverable-segment;
providing a response to said request for information, said response including said deliverable-representation, said current number of available deliverable-segments, said deliverable-segment cost associated with each available deliverable-segment; and
wherein said deliverable-representation is segmented into N total deliverable-representation-segments and a first sub-set of deliverable-representation-segments, corresponding to said current number of available deliverable-segments, and a second sub-set of deliverable-representation-segments, corresponding to a number of purchased deliverable-segments, are distinguished from each other.

2. The computer processor implemented method of claim 1, wherein said deliverable-representation is an image.

3. The computer processor implemented method of claim 2, wherein said first sub-set of deliverable-representation-segments and said second sub-set of deliverable-representation-segments are distinguished from each other by including additional markings in each of said second subset of deliverable-representation segments of said image.

4. The computer processor implemented method of claim 1, wherein said deliverable-representation is a textual representation.

5. The computer processor implemented method of claim 4, wherein said textual representation consists of n letters, each of said n letters being a deliverable-representation-segment, and said first sub-set of deliverable-representation-segments are provided in first color and said second sub-set of deliverable-representation-segments are provided in a second color.

6. The computer processor implemented method of claim 1, further comprising:
associating each of said deliverable-representation-segments with a corresponding deliverable-representation-segment identifier;
obtaining a deliverable-segment-purchase request, said deliverable-segment-purchase request including said segmented-purchasing-plan identifier, at least one of said deliverable-representation-segment identifiers, and deliverable-segment-payment information;
associating segmented-purchasing-plan participant with said deliverable-segment purchase request;
processing said deliverable-segment-payment information; and
providing a deliverable-segment-purchase notification.

7. The computer processor implemented method of claim 6, further comprising updating said initial segmented-purchasing-plan data with said deliverable-segment purchase request.

8. The computer processor implemented method of claim 7, wherein said deliverable-segment-purchase-request further includes a custom-deliverable-segment cost.

9. The computer processor implemented method of claim 6, further comprising:
obtaining message data associated with said deliverable-segment-purchase request; and
associating said message data with said deliverable-segment-purchase request with said corresponding deliverable-representation-segment identifier.

10. The computer processor implemented method of claim 1, further comprising:
determining that said deliverable-cost of said segmented-purchasing-plan has been funded;
obtaining a deliverable associated with said deliverable-selection; and
providing a notification to said deliverable-recipient, including information related to said purchase.

11. A computing device comprising:
a computer processing unit;
a network interface in data communication with said computer processing unit; and
memory in data communication with said computer processing unit, and containing executable instructions for causing said computer processing unit to perform a method comprising:
obtaining initial segmented-purchasing-plan data relating to a segmented-purchasing-plan, the initial segmented-purchasing-plan data including a deliverable-representation, a deliverable-cost, and an initial number (N) of available deliverable-segments;
associating said initial segmented-purchasing-plan data with a segmented-purchasing-plan identifier;
obtaining a request for information relating to said segmented-purchasing-plan identifier;
obtaining a current number of available deliverable-segments;
obtaining a deliverable-segment cost associated with each available deliverable-segment;
providing a response to said request for information, said response including said deliverable-representation, said current number of available deliverable-segments, said deliverable-segment cost associated with each available deliverable-segment; and
wherein said deliverable-representation is segmented into N total deliverable-representation-segments and a first sub-set of deliverable-representation-segments, corresponding to said current number of available deliverable-segments, and a second sub-set of deliverable-representation-segments, corresponding to a number of purchased deliverable-segments, are distinguished from each other.

12. The computing device of claim 11, wherein said deliverable-representation is an image.

13. The computing device of claim 1, wherein said first sub-set of m deliverable-representation-segments and said second sub-set of deliverable-representation-segments are distinguished from each other by including additional markings in each of said second subset of deliverable-representation segments of said image.

14. The computing device of claim 10, wherein said deliverable-representation is a textual representation.

15. The computing device of claim 14, wherein said textual representation consists of n number of letters; each of said n number of letters is a deliverable-representation-segment; and said first sub-set of deliverable-representation-segments are provided in first color and said second sub-set of deliverable-representation-segments are provided in a second color.

16. The computing device of claim 11, wherein said memory contains executable instructions for causing said computer processing unit to perform a method further comprising:
associating each of said deliverable-representation-segments with a corresponding deliverable-representation-segment identifier;
obtaining a deliverable-segment-purchase request, said deliverable-segment-purchase request including said segmented-purchasing-plan identifier, at least one of said deliverable-representation-segment identifiers, and deliverable-segment-payment information;
associating segmented-purchasing-plan participant with said deliverable-segment purchase request;
processing said deliverable-segment-payment information; and
providing a deliverable-segment-purchase notification.

17. The computing device of claim 16, wherein said memory contains executable instructions for causing said computer processing unit to perform a method further comprising updating said initial segmented-purchasing-plan data with said deliverable-segment purchase request.

18. The computing device of claim 17, wherein said deliverable-segment-purchase-request further includes a custom-deliverable-segment cost.

19. The computing device of claim 16, wherein said memory contains executable instructions for causing said computer processing unit to perform a method further comprising:
obtaining message data associated with said deliverable-segment-purchase request; and
associating said message data with said deliverable-segment-purchase request with said corresponding deliverable-representation-segment identifier.

20. The computing device of claim 10, wherein said memory contains executable instructions for causing said computer processing unit to perform a method further comprising:
determining that said deliverable-cost of said segmented-purchasing-plan has been funded;
obtaining a deliverable associated with said deliverable-selection; and
providing a notification to said deliverable-recipient, including information related to said purchase.
